(19) United States
(12) Patent Application Publication
(10) Pub. No.: US 2002/0036635 A1
(43) Pub. Date: Mar. 28, 2002

(54) Information processing apparatus and method for controlling power supply for a display thereof

(76) Inventor: Hajime Shimamoto, Tokyo (JP)

Correspondence Address: Finnegan, Henderson, Farabow,, Garrett & Dunner, L.L.P., 1300 I Street, N.W., Washington, DC, 20005-3315, US

(21) Appl. No.: 09/917,652

(22) Filed: Jul. 31, 2001

(30) Foreign Application Priority Data
Sep. 28, 2000 (JP) 2000-296361

(51) Int. Cl. G09G 5/00

(52) U.S. Cl. 345/211

(57) ABSTRACT

An information processing apparatus compatible to displays of different display types, such as TFT-type and STN-type, the apparatus by which an LVDS signal and an STN signal are supplied for the TFT-type LCD and the STN-type LCD, respectively via corresponding interface circuits, the interface circuits and an FET switch, which switches on/off the power supply for the display are controlled by means of separate gate signals.

### CROSS-REFERENCE TO RELATED APPLICATIONS

This application is based upon and claims the benefit of priority from the prior Japanese Patent Application No. 2000-296361, filed on Sep. 28, 2000; the entire contents of which are incorporated herein by reference.

### FIELD OF THE INVENTION

The present invention relates to an information processing apparatus, such as a computer, and method for controlling power supply for a display of the apparatus.

The present invention, more particularly, relates to an information processing apparatus which has a power supply control structure common to liquid crystal displays (LCDs) of different display types and can be connectable to any of them, and method for controlling an electric power supply voltage for a display of the apparatus.

### BACKGROUND

LCDs are used as displays of all note-type computers and of some of desk top computers because, compared with cathode ray tubes (CRTs), they are thinner and can save their space and power. Most LCDs in the present market are classified into two display types; a thin film transistor type (TFT-type) and a dual scan twisted nematic type (DSTN-type). The DSTN-type LCD is an improvement on a scan twisted nematic type (STN-type) LCD.

A TFT-type LCD is different from the STN-type LCD in both respects of the arrangement of the liquid crystal molecules and of the driving method. The TFT-type LCD is characterized by a high-quality display and high manufacturing cost, while the STN-type LCD is characterized by low manufacturing cost and remarkable flickering.

In a computer connectable to either the TFT-type LCD or the STN-type LCD, instructions to set the display specification necessary for the LCD are conventionally stored in a basic input/output system read only memory (BIOS-ROM), which is mounted on a motherboard. However, because it is difficult to use the motherboard in common, a computer is not designed to be connectable to LCDs of a plurality of display types. As a result, a user was compelled to unify display systems between a computer and an LCD, and can not change the display types of the LCD after the purchase of the computer.

In consideration of these circumstances, Japanese laid-open patent publication No. 9-114428 (Tokkaihei 9-114428) discloses an information processing apparatus connectable to displays of a plurality of display types, raising examples of a TFT-type LCD and an STN-type LCD. According to this publication, firstly, the display type of its LCD is identified based on a voltage signal from the inverter of the LCD. Secondly, some display specification setting instructions corresponding to the identified display type is readout from a BIOS, which stores several display specification setting instructions corresponding to several display types. Thirdly, a display controller outputs display signals to the LCD according to the instructions read out so that the LCD may display some data based on the display signal. Therefore, displays of a plurality display types can be connected to the same information processing apparatus.

The sequence of supplying the power supply for the LCD differs according to the display type of the LCD. However, no considerations to the common use of a power supply sequence are made in the publication. The TFT-type LCD can be inputted with an electric power supply voltage and a low voltage differential signaling (LVDS) at the same time. On the other hand, it is necessary to input an STN signal to the STN-type LCD after a predetermined time of supplying the electric power supply voltage because of its characteristics of the display specification. The electric power supply voltage is supplied for the LCD at the same time as the electric power supply voltage is supplied for the computer. Accordingly, using a power supply sequence in common is required to realize a computer connectable to any of LCDs of different display types.

Also, the electric power supply voltage to the STN-type LCD is continuously supplied until the power supply switch of the computer is switched off. Accordingly, even when a laptop computer having an LCD is connected to an external CRT and some data is displayed not on the CRT but on the LCD, an electric power supply voltage is supposed to be supplied for the LCD and the voltage is wastefully consumed.

### SUMMARY

In accordance with an embodiment of the present invention, there is provided an information processing apparatus capable of connecting to any of two or more displays of different display types. The information processing apparatus comprises a memory configured to store a plurality of instructions to set display specifications, means for identifying the display type of the display, a processor configured to set one of the display specifications stored in the memory according to the identified display type, a display controller configured to control the generation of display data according to the set display specification, a switch configured to switch on/off a power supply for the display, and a control circuit configured to control the switch, and to activate a transmission of the display data from the display controller to the display, separately from each other.

Also in accordance with an embodiment of the present invention, there is provided an information processing apparatus. The information processing apparatus comprises a display, a memory configured to store a plurality of instructions to set display specifications, means for identifying a display type of the display, a processor configured to set one of the display specifications stored in the memory according to the identified display type, a display controller configured to control the generation of display data according to the set display specification, a switch configured to switch on/off a power supply for the display, and a control circuit configured to control the switch, and to activate a transmission of the display data from the display controller to the display, separately from each other.

Further in accordance with an embodiment of the present invention, there is provided an information processing apparatus capable of connecting to any of two or more displays of different display types and of supplying a connected display with a display signal. The apparatus comprises a first memory to store a plurality of instructions to set display specifications the instructions which correspond to their several display types, means for identifying the display type of the display, a processor configured to execute one of the instructions corresponding to the identified display type to set a display specification, and to execute an instruction given by a user or a program operating in the apparatus to obtain data to be displayed, a second memory to store the obtained data, two or more interface circuits, which correspond to the different display types, configured to severally generate the display signal from the stored data, a display controller configured, according to the set display specification, to make the interface circuit corresponding to the identified display type generate the display signal, a switch configured to switch on/off a power supply for the display, and a control circuit configured to switch on the switch, and to supply the display with the generated display signal, separately from each other.

Also in accordance with an embodiment of the present invention, there is provided an information processing apparatus connectable to an STN-type LCD. The apparatus comprises a first memory to store an instruction to set a display specification according to the STN-type, a processor configured to execute the instruction, and to execute an instruction given by a user or a program operating in the apparatus to obtain data to be displayed, a second memory to store the obtained data, a buffer IC configured to generate an STN signal from the stored data, a display controller configured to make the buffer IC generate the STN signal, a switch configured to switch on/off a power supply for the LCD, and a control circuit configured to switch on the switch, and to supply the LCD with the generated STN signal, separately from each other.

Further in accordance with an embodiment of the present invention, there is provided a method for controlling power supply for a display of an information processing apparatus connectable to any of two or more displays of different display types. The method comprises identifying the display type of the display, setting a display specification corresponding to the identified display type, receiving an instruction from a user or a program operating in the apparatus, executing the received instruction to obtain data to be displayed, generating the display signal from the obtained data according to the set display specification, switching on a power supply for the display, and supplying the display with the generated display signal after a predetermined time of the switching on.

Additionally in accordance with an embodiment of the present invention, there is provided a method for controlling power supply for a display of an information processing apparatus connectable to an STN-type LCD. The method comprises receiving an instruction from a user or a program operating in the apparatus, executing the received instruction to obtain data to be displayed, generating an STN signal from the obtained data, switching on a power supply for the LCD, and supplying the LCD with the generated STN signal after a predetermined time of the switching on.

### BRIEF DESCRIPTION OF THE DRAWINGS

The accompanying drawings, which are incorporated in and constitute part of this specification, illustrate various embodiments and/or features of the invention and together with the description, serve to explain the principles of the invention. In the drawings:

FIG. 1 is a block diagram showing a main configuration of a computer consistent with an embodiment of the present invention;

FIG. 2 is a block diagram showing a configuration of a power supply control structure consistent with an embodiment of the present invention;

FIG. 3 is a flow chart showing an example of sequence for beginning to supply a power supply for an LCD;

FIG. 4 is a time chart showing an example of sequence for beginning to supply a power supply for an LCD;

FIG. 5 is a flow chart showing an example of sequence for finishing supplying a power supply for an LCD; and

FIG. 6 is a time chart showing an example of sequence for finishing supplying a power supply for an LCD.

### DETAILED DESCRIPTION

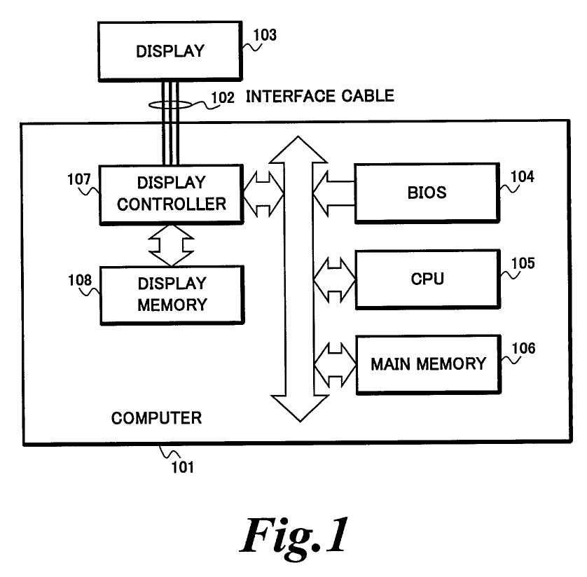

Hereinafter an embodiment of the present invention is described by referring to the drawings. FIG. 1 is a block diagram showing a main configuration of a computer consistent with an embodiment of this present invention. A computer 101 is connected to a display 103 via an interface cable 102. The computer 101 comprises a BIOS 104, a CPU 105, a main memory 106, a display controller 107, and a display memory 108.

The BIOS 104 stores basic operation instructions for controlling both the display controller 107 and a control application specific integral circuit (control ASIC) 212 (described later) and for setting a display specification according to the display type of the display 103. The CPU 105 reads out the operation instructions from the BIOS 104 and executes them. The CPU 105 first performs a boot to set peripheral devices, such as a floppy disc drive or a hard disc drive. The CPU 105 also executes instructions inputted by a user or by an application program operating on the computer 101 and stores data to be outputted to the display 103 via the display controller 107 into the display memory 108 in the process of the execution. The display controller 107, controlling accesses by the CPU 105, reads out the data stored in the display memory 108 and outputs the data to the display 103 via the interface cable 102. The display controller 107 also provides display 103 with control signals, such as a frame pulse (FP) signal, a latch pulse (LP) signal, and an enable (ENAB) signal, and a clock (CLK) signal.

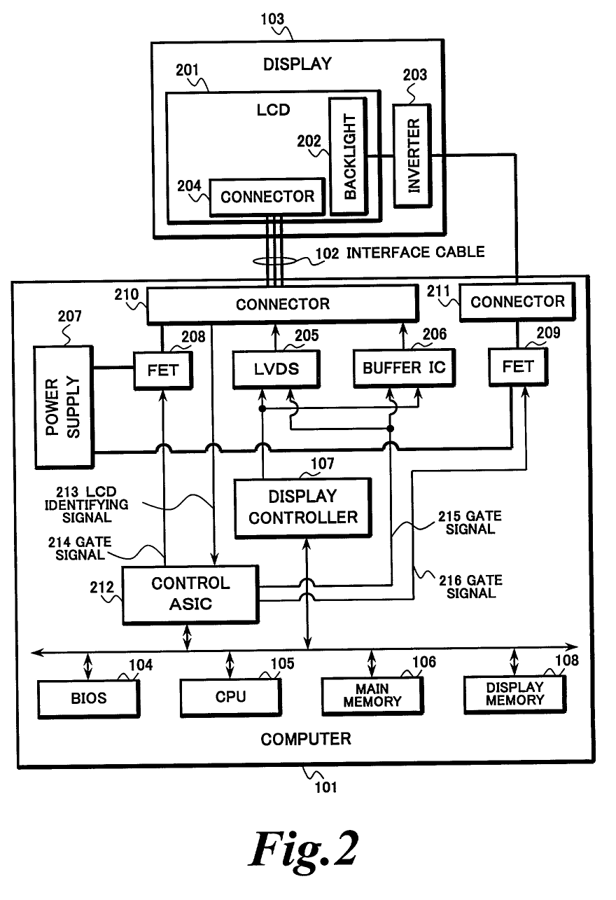

FIG. 2 is a block diagram showing a configuration of a power supply control structure consistent with this embodiment. The display 103 comprises an LCD 201, a backlight 202, an inverter 203, and a connector 204. The LCD 201 may be a TFT-type LCD or an STN-type LCD, and has a lighting system including a backlight 202. The inverter 203 supplies a high voltage necessary for operation of the backlight 202. The connector 204, connected to the interface cable 102, is a signal interface connector provided in the display 103.

In addition to the main configuration shown in FIG. 1, the computer 101 comprises an LVDS 205, a buffer IC 206 such as an HC244, a power supply 207, a field effect transistor (FET) 208 and 209, a connector 210 and 211, and a control ASIC 212. The LVDS 205 and the buffer 206 are severally interface circuits with the LCD 201. According to instructions from the display controller 107, the LVDS 205 generates LVDS signals for the TFT-type LCD and the buffer IC 206 generates STN signals, such as data (DATA) signals, CLK signals, FP signals, and LP signals, for the STN-type LCD.

The power supply 207 supplies an electric power supply voltage for the LCD 201 via the FET 208, the connector 210, the interface cable 102, and the connector 204 so that the display 103 may display letters or images. The power supply 207 also supplies an electric power supply voltage for the inverter 203 via the FET 209 and a connector 211 so that the inverter 203 may drive the backlight 203.

The control ASIC 212 having a general register controls various power supply sequences. When the control ASIC 212 detects an LCD identifying signal 213 from the connector 210, BIOS 104 identifies the display type of the connected LCD 201. The control ASIC 212 supplies a gate signal 214 for the FET 208 to control supply of the electric power supply voltage for the display 103 and supplies a gate signal 216 for the FET 209 to control supply of the electric power supply voltage for the inverter 203 at the same time. In addition to the display type of the LCD 201, the LCD identifying signal 213 may include data regarding the resolution of a super video graphics array (SVGA) or an extended graphics array (XGA). The control ASIC 212 switches on or off the LVDS 205 and the buffer IC 206 by supplying a gate signal 215 according to instructions by the BIOS 104.

There are various methods for identifying the display type of the LCD 201 by means of the control ASIC 212. An example of these methods may be as follows. The control ASIC 212 and the connector 210 are connected via two control lead wires W1 and W2 for transmitting the LCD identifying signal 213; each wire's terminal end in the connector 210 is open. Both wires W1 and W2 are pulled up to a predetermined voltage V_{cc}. Therefore, the control ASIC 212 detects a high level voltage (V_{cc}) via each of the wires W1 and W2 when no LCD is connected to the computer 101. This condition of the LCD identifying signal 213 is symbolized as (W1=1, W2=1).

A TFT-type LCD is provided with a structure making the wire W1 grounded when connected to the computer 101. A condition where the control ASIC 212 detects a low level voltage (GND) only via the wire W1 when the TFT-type LCD is connected to the computer 101 is symbolized as (W1=0, W2=1) . On the other hand, an STN-type LCD is provided with a structure making the wire W2 grounded when connected to the computer 101. A condition where the control ASIC 212 detects a low level voltage (GND) only via the wire W2 when the STN-type LCD is connected to the computer 101 is symbolized as (W1=1, W2=0). In this way, the identifying the display type of the connected LCD 201 based on the LCD identifying signal 213 can be realized.

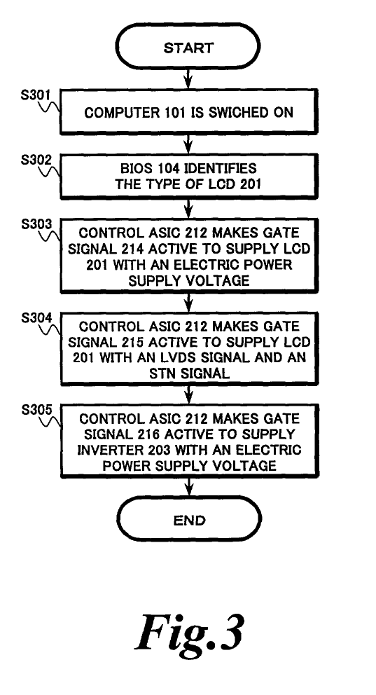

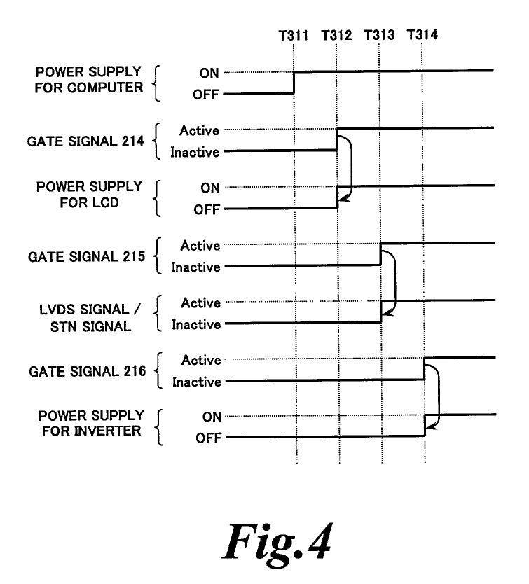

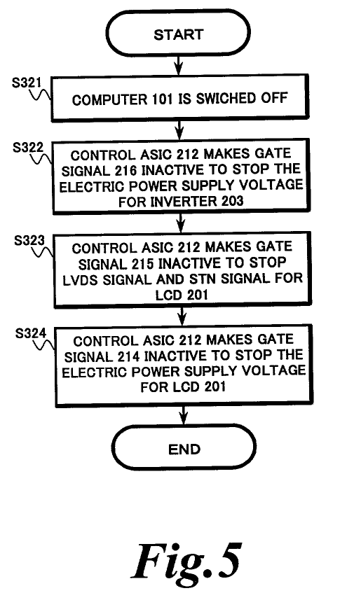

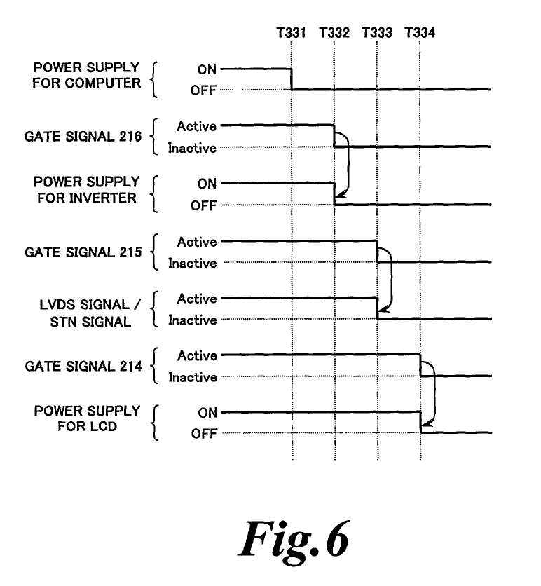

Next, the power supply sequence according to this embodiment is described by referring to FIGS. 3 to 6. FIGS. 3 and 5 are flowcharts showing examples of power supply control sequence, and FIGS. 4 and 6 are time charts for the examples. First, sequence for beginning to supply an electric power supply voltage for an LCD is described by referring to FIGS. 3 and 4.

At a time T311, when the power supply switch of the computer 101 is on (step S301), the control ASIC 212 detects the LCD identifying signal 213 and stores it in a resister in the CPU 105, and the CPU 105 reads out necessary instructions stored in the BIOS 104 and executes them to perform the boot process. That is, the CPU 105 executes the instructions for setting the specification of the peripheral devices and then executes the instructions for identifying the display type of the LCD 201 based on the LCD identifying signal 213 stored in the resister (step S302). As a result, the CPU 105 executes the display specification setting instruction according to the display type of the LCD 201 to set the display type on the display controller 107.

When the control ASIC 212 makes a gate signal 214 active according to an instruction by the BIOS 104 at a time of T312, the FET 208 is switched on at the almost same time, and the display 103 is supplied with the electric power supply voltage (step S303). When the control ASIC 212 makes a gate signal 215 active at a time T313, for example, after 10 ms of the time T312, the LCD 201 is supplied with the LVDS signal or the STN signal at the almost same time (step S304).

Further, when the control ASIC 212 makes a gate signal 216 active at a time T314, for example, after several 100 ms, the FET 209 is switched on and the inverter 203 is supplied with the electric power supply voltage at the almost same time. One of the reasons of the delay of the activation of the inverter 203 is not to show an abnormal display on the LCD 201.

Next, sequence for finishing supplying an electric power supply voltage for an LCD is described by referring to FIGS. 5 and 6. The power supply switch of the computer 101 is off at a time T331 (STEP S321). When the control ASIC 212 makes the gate signal 216 inactive according to an instruction by the BIOS 104 at a time T332, after a certain time of the T331, the FET 209 is switched off at the almost same time, and the electric power supply voltage supplied for the inverter 203 is terminated (STEP S322).

When the control ASIC 212 makes the gate signal 215 inactive at the time T333, after a certain time of the time T332, the supply of the LVDS signal or the STN signal is terminated (STEP 323). Furthermore, when the control ASIC 212 makes the gate signal 214 inactive at the time T334, after a certain time of the time T333, the FET 208 is switched off at the almost same time, and the electric power supply voltage for the LCD 201 is terminated.

According to this embodiment, the common power supply control structure, which is compatible to both an STN-type LCD and a TFT-type LCD, can be realized. Therefore, the system substrate can be used in common with these LCDs of different display type. In the above, the description is made by taking an example of LCDs of the STN-type and of the TFT-type. However, the power supply control structure can be applied commonly to other displays of different display types, such as a plasma display, because the electric power supply voltage and the timing of supplying a data signal can be adjusted in accordance with their several display specifications.

Because the electric power supply voltage for the LCD 201 is controlled by means of the FET 208, the control ASIC 212 can make the gate signal 214 inactive according to the instruction by the BIOS 104 to terminate the electric power supply voltage for the LCD 102 when a display output is not supplied for the LCD 201. That is, just the electric power supply voltage for the LCD 102 can be cut without switching off the power switch of the computer 101. Therefore, the power consumption can be reduced when the electric power supply voltage should be lowered in the computer 101. The power supply control structure can also be applied to an STN-type LCD for the purpose of the reduction of the power consumption.

What is claimed is:

1. An information processing apparatus capable of connecting to any of two or more displays of different display types, comprising:
a memory configured to store a plurality of instructions to set display specifications;
means for identifying the display type of the display;
a processor configured to set one of the display specifications stored in the memory according to the identified display type;
a display controller configured to control the generation of display data according to the set display specification;
a switch configured to switch on/off a power supply for the display; and
a control circuit configured to control the switch, and to activate a transmission of the display data from the display controller to the display, separately from each other.

2. An information processing apparatus, comprising:
a display;
a memory configured to store a plurality of instructions to set display specifications;
means for identifying a display type of the display;
a processor configured to set one of the display specifications stored in the memory according to the identified display type;
a display controller configured to control the generation of display data according to the set display specification;
a switch configured to switch on/off a power supply for the display; and
a control circuit configured to control the switch, and to activate a transmission of the display data from the display controller to the display, separately from each other.

3. An information processing apparatus capable of connecting to any of two or more displays of different display types and of supplying a connected display with a display signal, comprising:
a first memory to store a plurality of instructions to set display specifications, the instructions which correspond to their several display types;
means for identifying the display type of the display;
a processor configured to execute one of the instructions corresponding to the identified display type to set a display specification, and to execute an instruction given by a user or a program operating in the apparatus to obtain data to be displayed;
a second memory to store the obtained data;
two or more interface circuits, which correspond to the different display types, configured to generate the display signal from the stored data, severally;
a display controller configured, according to the set display specification, to make the interface circuit corresponding to the identified display type generate the display signal;
a switch configured to switch on/off a power supply for the display; and
a control circuit configured to switch on the switch, and to supply the display with the generated display signal, separately from each other.

4. The apparatus of claim 3, wherein:
the apparatus is connectable to either a TFT-type LCD or an STN-type LCD; and
the interface circuits includes a first circuit to generate an LVDS signal for the TFT-type LCD and a second circuit to generate an STN signal for the STN-type LCD, severally from the stored data.

5. The apparatus of claim 3, further comprising an electric power supply unit configured to supply the power supply for the display.

6. The apparatus of claim 3, wherein the switch comprises an FET.

7. The apparatus of claim 3, wherein the control circuit is configured to switch on the switch, and to supply the display with the generated display signal after a predetermined time of the switching on.

8. The apparatus of claim 7, wherein the control circuit is configured to terminate the supply of the generated display signal for the display, and to switch off the switch after a predetermined time of the terminating.

9. The apparatus of claim 3, wherein the identifying means includes:
a connector configured to receive one of identifying signals, which correspond to their several display types, from the display; and
means for determining the display type of the display based on the received signal.

10. The apparatus of claim 9, wherein:
the connector includes two or more terminals configured to receive a combination of voltages as the signal from the display; and
the determining means is configured to determine the display type based on the combination of voltages.

11. An information processing apparatus connectable to a STN-type LCD, comprising:
a first memory to store an instruction to set a display specification according to the STN-type;
a processor configured to execute the instruction, and to execute an instruction given by a user or a program operating in the apparatus to obtain data to be displayed;
a second memory to store the obtained data;
a buffer IC configured to generate an STN signal from the stored data;
a display controller configured to make the buffer IC generate the STN signal;
a switch configured to switch on/off a power supply for the LCD; and
a control circuit configured to switch on the switch, and to supply the LCD with the generated STN signal, separately from each other.

12. The apparatus of claim 11, further comprising an electric power supply unit to supply the power supply for the LCD.

13. The apparatus of claim 11, wherein the switch comprises an FET.

14. The apparatus of claim 11, wherein the control circuit is configured to switch on the switch, and to supply the LCD with the generated STN signal after a predetermined time of the switching on.

15. The apparatus of claim 14, wherein the control circuit is configured to terminate the supply of the generated STN signal for the LCD, and to switch off the switch after a predetermined time of the terminating.

16. A method for controlling power supply for a display of an information processing apparatus connectable to any of two or more displays of different display types, comprising:
identifying the display type of the display;
setting a display specification corresponding to the identified display type;
switching on a power supply for the display; and
supplying the display with a display signal after a predetermined time of the switching on.

17. The method of claim 16, further comprising:
receiving an instruction from a user or a program operating in the apparatus;
executing the received instruction to obtain data to be displayed;
generating the display signal from the obtained data according to the set display specification;

18. The method of claim 17, further comprising:
terminating the supply of the generated display signal for the display; and
switching off the power supply for the display after a predetermined time of the terminating.

19. The method of claim 17, wherein the setting includes:
executing one of a plurality of instructions stored in a memory mounted on the apparatus, the instructions that correspond to their several display types.

20. The method of claim 17, wherein:
the generating is performed by one of two or more interface circuits, which corresponds to the identified display type, the circuits which correspond to the different display types.

21. The method of claim 20, wherein:
the apparatus is connectable to either a TFT-type LCD or an STN-type LCD; and
the generating includes generating an LVDS signal and an STN signal for the TFT-type LCD and the STN-type LCD, respectively from the stored data.

22. The method of claim 16, wherein the identifying includes:
receiving one of identifying signals from the display, the identifying signals which correspond to their several display types; and
determining the display type of the display based on the received identifying signal.

23. The method of claim 22, wherein:
the receiving includes receiving a combination of voltages as the identifying signal; and
the determining includes determining the display type based on the combination of voltages.

24. A method for controlling power supply for a display of an information processing apparatus connectable to a STN-type LCD, comprising:
receiving an instruction from a user or a program operating in the apparatus;
executing the received instruction to obtain data to be displayed;
generating an STN signal from the obtained data;
switching on a power supply for the LCD; and
supplying the LCD with the generated STN signal after a predetermined time of the switching on.

25. The method of claim 26, further comprising:
terminating the supply of the generated display signal for the LCD; and
switching off the power supply for the LCD after a predetermined time of the terminating.
